(19) United States
(12) Patent Application Publication
(10) Pub. No.: US 2021/0022942 A1
(43) Pub. Date: Jan. 28, 2021

(54) Mobilisation Device

(71) Applicant: Bungan Industries Pty Ltd, Riverview (AU)

(72) Inventor: Peter Gregory, Mona Vale (AU)

(21) Appl. No.: 16/937,076

(22) Filed: Jul. 23, 2020

(30) Foreign Application Priority Data
Jul. 24, 2019 (AU) 2019902613

(51) Int. Cl. A61H 1/02; A63B 21/00

(52) U.S. Cl. CPC A61H 1/0218; A61H 1/0296; A61H 1/0237; A61H 1/0274; A61H 2201/169; A63B 21/4039; A61H 2201/1607; A61H 2201/1253; A63B 21/4033

(57) ABSTRACT

A mobilisation device may include two or more therapeutic surfaces for applying concentrated pressure to an area of a user. The therapeutic surfaces being connected by at least one support formation. The device may include an arcuate formation extending from a distal end of the at least one support formation. The arcuate formation may define a therapeutic surface. The two or more therapeutic surfaces may be linearly arranged therapeutic surfaces. The mobilisation device may include a base connected to a proximal end of the at least one support formation. The base may be contoured on at least one surface, thereby to define a recess into which a user's head may rest. The mobilisation device may be oriented to define a short configuration or a tall configuration.

### CROSS-REFERENCE TO RELATED PATENT APPLICATIONS

The present application claims priority to Australian Patent Application No. 2019902613, filed Jul. 24, 2019, the entire disclosure of which is incorporated herein by reference.

### FIELD OF THE INVENTION

The present invention relates to mobilisation devices. More particularly, the invention relates to devices for mobilising the spine and muscles in the neck, back, legs and arms of a user.

The invention has been developed primarily for use as a device for mobilising the spine and muscles in the neck, back, legs and arms of a user. While some embodiments will be described herein with particular reference to that application, it will be appreciated that the invention is not limited to such a field of use, and is applicable in broader contexts.

### BACKGROUND

The following discussion of the prior art is intended to facilitate an understanding of the invention and to enable the advantages of it to be more fully understood. It should be appreciated, however, that any reference to prior art throughout the specification in no way be considered as an admission that such art is widely known or forms part of common general knowledge in the field.

Known devices for providing mobilisation to joints and muscles include cylindrical foam rollers. Foam rollers attack the trigger points of muscles. However, they are necessarily limited by the fixed radius of the roller and the fixed height of the roller, which cannot apply a highly concentrated amount of pressure. Different foam rollers with different heights and radii are required for mobilising different areas of the body. Furthermore, foam rollers are not able to provide a high amount of pressure to the muscles.

It is an object of the present invention to overcome or ameliorate one or more of the disadvantages of the prior art, or at least provide a useful alternative.

### SUMMARY OF THE INVENTION

According to one aspect of the present invention, there is provided a mobilisation device, including:

two or more therapeutic surfaces for applying concentrated pressure to an area of a user, the therapeutic surfaces being connected by at least one support formation.

In one embodiment, the mobilisation device includes an arcuate formation extending from a distal end of the at least one support formation. Preferably, a first therapeutic surface is defined by the arcuate formation. The arcuate formation is preferably substantially curved. Preferably, the arcuate formation is substantially cylindrical. In other embodiments, the arcuate formation may be capsule-shaped. In a further embodiment, the arcuate formation may be substantially spherical. In yet another embodiment, the arcuate formation may be semicylindrical.

Preferably, the first therapeutic surface is a linearly arranged therapeutic surface. More preferably, first therapeutic surface is substantially smooth. In other embodiments, the first therapeutic surface includes a plurality of massage protrusions.

In one embodiment, the radius of curvature of the first therapeutic surface is in the range of 10 mm to 20 mm, preferably 12 mm to 18 mm. In one particularly preferred embodiment, the radius of curvature of the first therapeutic surface is 17.5 mm. In some embodiments, a radius of curvature of the first therapeutic surface is the same as the radius of curvature of the second therapeutic surface. In another embodiment a radius of curvature of the first therapeutic surface is the same as the radius of curvature of the third therapeutic surface. In an alternative embodiment, the radius of curvature of the first therapeutic surface is different to the radius of curvature of the second therapeutic surface or the third therapeutic surface. In further embodiments, a radius of curvature of each of the two or more therapeutic surfaces are preferably the same. In other embodiments, a radius of curvature of each of the two or more therapeutic surfaces are different.

In some embodiments, the mobilisation device includes a base connected to a proximal end of the at least one support formation. Preferably, the base is substantially planar in shape. In some embodiments the sides of the base are a curved shape. In other embodiments, the sides of the base are substantially polygonal. In a further embodiment, the sides of the base have a narrowed mid-section such that they define a peanut shape. In another embodiment, the sides of the base may be stadium-shaped. More preferably, the base is formed so as to have predetermined measurements. In some embodiments, the predetermined length of the base is in the range of 140 mm to 150 mm. In one particularly preferred embodiment, the length of the base is 130 mm. In some embodiments, the predetermined width of the base is in the range of 80 mm to 100 mm. In one particularly preferred embodiment, the width of the base is 90 mm.

In other embodiments, the base may be contoured. Preferably, the base is contoured on at least one surface. Preferably, the base is contoured on at least one surface. More preferably, the contoured surface defines a recess between the first end and a second end. Preferably, the base is contoured on at least one surface, thereby to define a recess into which a user's head may rest.

Preferably, a second therapeutic surface is defined by a first end of the base. the first end is preferably substantially arcuate to define the second therapeutic surface. More preferably, the first end is substantially cylindrical. In other embodiments, the second therapeutic surface is a linearly arranged therapeutic surface. In some embodiments, the radius of curvature of the first end is 10 mm to 15 mm, preferably 11.5 mm to 13.5 mm. In one particularly preferred embodiment, the radius of curvature of the second therapeutic surface is 12.5 mm.

In some embodiments, the base has a second end defining a third therapeutic surface. Preferably, the second end is substantially arcuate to define the third therapeutic surface. More preferably, the second end is substantially cylindrical. In other embodiments, the third therapeutic surface is a linearly arranged therapeutic surface.

In some embodiments, the radius of curvature of the second therapeutic surface is the same as the radius of curvature of the third therapeutic surface. In an alternative embodiment, the radius of curvature of the second therapeutic surface is different to the radius of curvature of the third therapeutic surface.

In further embodiments, the at least one support formation is elongate. Preferably, the at least one support formation extends from the base at a point intermediate the first end and the second end. In some embodiments, the point intermediate the first end and the second end may include part of at least one of the first end and the second end. Preferably, the support formation is substantially cylindrical. More preferably, the cylindrical support formation is formed so as to have a predetermined radius. In some embodiments, the predetermined radius of the cylindrical support formation is in the range of 2.5 mm to 7.5 mm. In one particularly preferred embodiment, the radius of the cylindrical support formation is 5 mm. In another embodiment, the predetermined radius of the cylindrical support formation is in the range of 9 mm to 10 mm Preferably, the support formation is formed so as to have a predetermined length. In some embodiments, the predetermined length of the support formation may be varied such that, when in a tall configuration, the height of the first therapeutic surface is resting above the floor by 180 mm to 220 mm. In another embodiment, the support formation may be varied such that, when in a short configuration, the height of the second therapeutic surface is resting above the floor by 50 mm to 120 mm.

Preferably, the mobilisation device includes two support formations. More preferably, the two support formations are arranged substantially in parallel to one another. In further embodiments, the two support formations extend from the base at points intermediate the first end and second end. In some embodiments, the distance between the two support formations is in the range of 70 mm to 90 mm, more preferably 75 mm to 85 mm. In one particularly preferred embodiment, the distance between the two support formations is 80 mm. In alternative embodiments, the support formations may not be arranged parallel to one another, but instead may be angled towards one another such that the distal ends of the support formations are closer than the proximal ends, or such that the proximal ends of the support formations are closer than the distal ends. In some embodiments, the two support formations extend from the base at points intermediate the two ends of the base.

In some embodiments, the length of the at least one support formation is fixed. In other embodiments, the length of the at least one support formation is selectively adjustable between a retracted position in which the support formation has a first length and an extended position in which the support formation has a second length, wherein the second length is greater than the first length. In such embodiments, the support formation may be lockable in the retracted position for storage and the extended position for use, as required. In some embodiments, the length of the support formation may be lockable at one or more positions intermediate the retracted and extended position, as desired.

Preferably, the at least one support formation is integrally formed with the base. Alternatively, or additionally, in some embodiments the at least one support formation is integrally formed with the arcuate formation.

In another embodiment, the at least one support formation may be formed separately and attached to the base and/or the arcuate formation. In another embodiment, the at least one support formation may be releasably engageable with the base and/or the arcuate formation. In other embodiments, the base further includes at least one tubular channel for receiving and engaging one end of the at least one support formation. Preferably, the tubular channel extends at least partway through the base. Preferably, the tubular channel extends above the surface of the base. More preferably, the tubular channel is at least partially surrounded by sloped edges thereby to reinforce the support formation. In further embodiments, the arcuate formation includes at least one tubular channel for engaging another end of the at least one support formation.

Preferably, the mobilisation device is at least partially formed by injection moulding. In one embodiment, the mobilisation device is entirely manufactured by injection moulding. In a further embodiment, the mobilisation device is composed of at least one of a range of suitable materials. More preferably, the mobilisation device is composed at least partially of glass filled nylon. In other embodiments, the mobilisation device may be composed at least partially of wood, aluminium, and/or silicon.

As discussed in more detail below, in certain embodiments, the mobilisation device can be arranged such that the device is oriented to define a short configuration. Preferably, the second therapeutic surface applies concentrated pressure on an area of a user when used in the short configuration. This is advantageous in providing a mobilisation for joints and muscles on all areas of the body including at least a user's spine and muscles in the neck, back, legs and arms. In other embodiments, the mobilisation device can be arranged such that the device is oriented to define a tall configuration. Preferably, the first therapeutic surface applies concentrated pressure on an area of a user when used in the tall configuration. This is advantageous in providing mobilisation with relatively more pressure than the short configuration for at least the user's muscles in the legs, lower back, upper back, and calves.

In some embodiments, the predetermined height of the mobilisation device in the tall configuration is in the range of 180 mm to 220 mm. In other embodiments, the predetermined height of the mobilisation device in the short configuration in the range of 50 mm to 120 mm.

According to a further aspect of the present invention, there is provided a mobilisation device, including: two or more surfaces for applying concentrated pressure to an area of a user, the therapeutic surfaces being connected by at least one support formation.

In some embodiments, the device two or more contact surfaces. In some embodiments, the device includes two or more linear contact surfaces.

### BRIEF DESCRIPTION OF THE DRAWINGS

Preferred embodiments of the disclosure will now be described, by way of example only, with reference to the accompanying drawings in which:

FIG. 1 is a perspective view showing an embodiment of a mobilisation device in a short configuration;

FIG. 2 is a perspective view showing the embodiment of the mobilisation device in FIG. 1 in a tall configuration;

FIG. 3 is a perspective view showing the embodiment of the mobilisation device in FIG. 1 in the short configuration;

FIGS. 4A to 4B show the embodiment of the mobilisation device in use for treating hamstrings;

FIGS. 5A and 5B show the embodiment of the mobilisation device in use for treating calf muscles;

FIG. 6 shows the embodiment of the mobilisation device in use for treating quadriceps;

FIGS. 7A to 7B show the embodiment of the mobilisation device in use for treating the neck;

FIG. 8 shows the embodiment of the mobilisation device in use for treating the pectoral muscles;

FIGS. 9A to 9C show the embodiment of the mobilisation device in use for treating the back; and

FIG. 10 shows the embodiment of the mobilisation device in use for treating shin splints.

### DETAILED DESCRIPTION

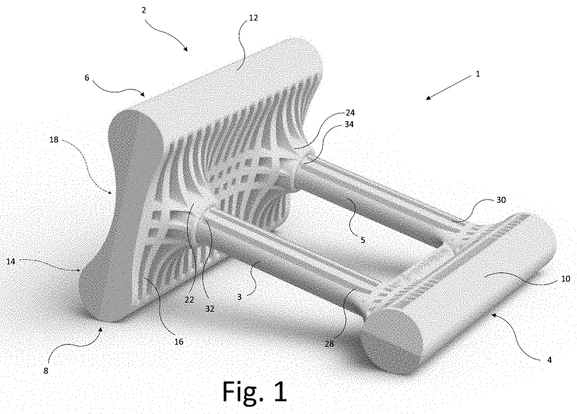

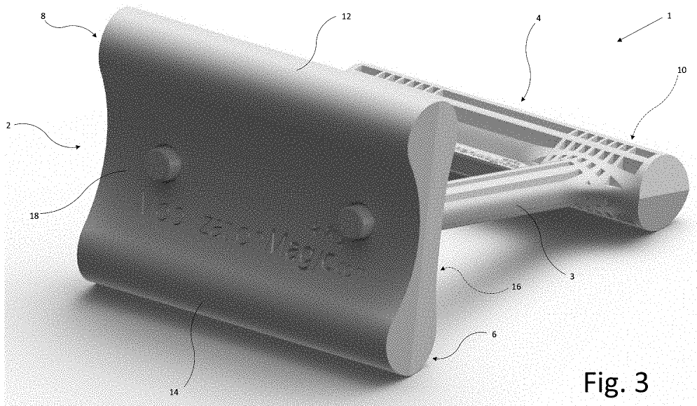

Referring initially to FIGS. 1 to 3, a preferred embodiment of a mobilisation device 1 is described. The device 1 includes an arcuate formation 4, defining a first therapeutic surface 10, the arcuate formation extending from two support formations 3 and 5. The device further includes a base 2 having a first end 6 defining a second therapeutic surface 12. The two support formations extend from the base 2.

The base has a first end 6 and a second end 8. The second end defines a third therapeutic surface. The base is substantially planar and has sides which are substantially peanut-shaped. The base is formed so as to have predetermined measurements. In the preferred embodiment, the predetermined length of the base is 130 mm and the predetermined width of the base is 90 mm. However, the length of the base may be in the range of 140 mm to 150 mm, and the width of the base may be in the range of 80 mm to 100 mm.

The sides of the base 2 are substantially similar in surface area. However, it will be appreciated that in some embodiments the first side and the second side may differ in surface area.

In the preferred embodiment, the radius of curvature of the second therapeutic surface is 12.5 mm. However, it will be appreciated that the radius of curvature may vary to any suitable size, and may be in the range of 10 mm to 15 mm More particularly, the radius of curvature may be in the range of 11.5 mm to 13.5 mm. The second therapeutic surface may have the same radius of curvature as the third therapeutic surface 8, however it will be appreciated that the second therapeutic surface 8 may have a different radius of curvature than the third therapeutic surface.

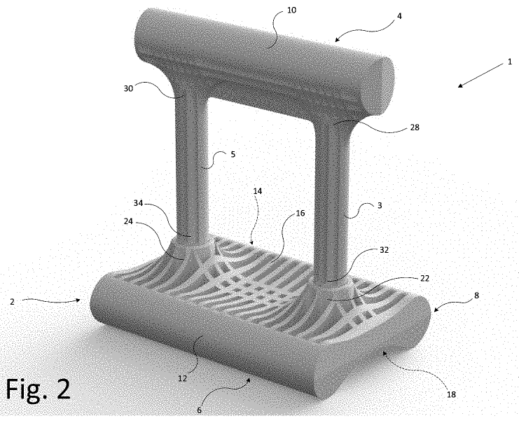

The base is contoured on at least one of its surfaces. In the preferred embodiment, the base is symmetrically contoured on both an upper surface 16 and lower surface 18 at a point intermediate the first end 6 and the second end 8. It will be appreciated that the point intermediate the first end and second end may be separate from the ends 6 and 8, or it may at least partially include or overlap with the ends 6 and 8. The contouring of the base thereby defines a recess or a waisted portion between the two ends 6 and 8. When in a short configuration, as shown in FIG. 1, a recess on the lower surface 18 allows for a greater range of motion of the user's head when in use. The recess provides more space for a user's head to hang over the first end 6 when the user to lays their neck over the second therapeutic surface, thereby supporting an increased rotation of the head. This increased rotation enables better mobilisation of the spine and is more comfortable for the user. When in a tall configuration, as shown in FIG. 2, the contour on the lower surface 18 allows for greater stability and balance when in use.

The first end of the base defining a second therapeutic surface is substantially curved. The second therapeutic surface is a linearly arranged therapeutic surface. The base 2 further includes a second end 8 defining a third therapeutic surface 12. The second end defining a third therapeutic surface is substantially curved. In the preferred embodiment, the first end 6 and the second end 8 are thereby substantially cylindrical in shape, and the second therapeutic surface 12 and the third therapeutic surface 12 are linearly arranged therapeutic surfaces. In some embodiments, the arcuate formation 4 defines a first surface, the first end of the base defines a second surface and the second end of the base defines a third surface. In some embodiments, the first surface, second surface and third surface are contact surfaces.

In a preferred embodiment of the device as shown in FIGS. 1 to 3, the device 1 includes two elongate support formations 3 and 5. The two support formations are substantially identical and cylindrical in shape, having a predetermined radius of 9.5 mm However, the radius may be in the range of 9 mm to 10 mm. The support formations 3 and 5 are arranged substantially in parallel and extend from the base at points 22 and 24 intermediate the first end and the second end, wherein points 22 and 24 are disposed axially lengthways along the base 2. It will be appreciated that the points 22 and 24 intermediate the first end and the second end may at least partially include or overlap with the ends 6 and 8. In the preferred embodiment, the distance between the two support formations 3 and 5 is about 80 mm. However, the distance between the two support formations may be any suitable distance, subject to the length of the base. For example, the distance between the two support formations 3 and 5 may be in the range of 70 mm to 90 mm, or more particularly 75 mm to 85 mm.

The support formations 3 and 5 are formed so as to have a predetermined length. It will be appreciated that any suitable length may be used for the support formations. The predetermined length of the support formation may be varied such that, when in a tall configuration, the height of the first therapeutic surface is resting above the floor by 180 mm to 220 mm. The support formation may be varied such that, when in a short configuration, the height of the second therapeutic surface is resting above the floor by 50 mm to 120 mm. Furthermore, it will be appreciated that the support formations may be of identical or different lengths. In other embodiments not shown in the Figures, the support formations 3 and 5 may not be arranged parallel to one another, but instead may be angled towards one another such that the distal ends 28 and 30 of the support formations are closer than the proximal ends 32 and 34, or such that the proximal ends 32 and 34 of the support formations are closer than the distal ends 28 and 30.

In a further alternative embodiment not shown in the Figures, the length of the support formations 3 and 5 may be selectively adjustable between a retracted position in which the support formations have a first length and an extended position in which the support formation has a second length, wherein the second length is greater than the first length. In such embodiments, the support formation may be lockable in the retracted position for storage and the extended position for use, as required. The length of the support formation may be lockable at one or more positions intermediate the retracted and extended position, as desired. This embodiment is also applicable a mobilisation device having a single support formation.

As shown in FIGS. 1 to 3, the proximal ends 32 and 34 support formations 3 and 5 are integrally formed with the base 2. Further, the distal ends 28 and 30 of the support formations 3 and 5 are integrally formed with the arcuate formation 4. When the support formations are integrally formed, the distal ends 28 and 30 or proximal ends 32 and 34 may be surrounded by gradually sloping surfaces.

In an alternative embodiment (not shown), the support formations may be formed separately and attached to the base and/or the arcuate formation. In that embodiment, the base includes two tubular channels for receiving and engaging the proximal ends 32 and 34 of the support formations, which extend at least partway through the base 2. The support formations may be releasably engageable with the channels so that the mobilisation device may be taken apart. For example, the base 2 and the arcuate formation 4 may be removable from the support formations to replace them with a secondary base (not shown) or secondary arcuate formation (not shown) having different curvature or therapeutic elements thereby to provide a different therapeutic effect for the user.

The tubular channels may extend above the base and are at least partially surrounded by sloped edges thereby to reinforce the support formation. In a similar manner, the arcuate formation may also include tubular channels for engaging the distal ends 28 and 30 of the support formations 3 and 5.

The arcuate formation 4 is substantially cylindrically shaped. However, it will be appreciated that the arcuate formation may be substantially spherical, capsule-shaped, semicylindrical, at least partially curved, or any other shape which is suitable for use as an arcuate formation. The arcuate formation 4 defines a first therapeutic surface 10 which is a linearly arranged therapeutic surface. The first therapeutic surface 10 is substantially smooth. However, in other embodiments, the first therapeutic surface may include a plurality of massage protrusions, or additional therapeutic elements to enhance the massaging effect. In the preferred embodiment, the radius of curvature the first therapeutic surface is 17.5 mm. In other embodiments, the radius of curvature is in the range of 10 mm to 20 mm, and more particularly in the range of 12 mm to 18 mm however, it will be appreciated that any suitable radius of curvature may be used.

In the preferred embodiment, the radius of curvature of the therapeutic surface 4 is the same as the curvature of the second therapeutic surface 12 and the third therapeutic surface 14. However, in alternative embodiments, the radius of curvature of the first therapeutic surface 10 may be different to the curvature of either the second therapeutic surface 12 or the third therapeutic surface 14, or it may be different to both the second therapeutic surface and the third therapeutic surface. The radii of curvature of the first therapeutic surface 10, second therapeutic surface 12 and third therapeutic surface 14 may be chosen to specifically direct a certain amount of concentrated pressure while the device is in use. The amount of pressure may be increased or decreased by choosing a specific radius of curvature of the therapeutic surfaces 10, 12, 14.

The mobilisation device 1 is preferably formed by injection moulding. It may be formed in one single mould, or in a number of different moulds and then assembled. In another embodiment, at least part of the mobilisation device is manufactured by a process other than injection moulding. Although injection moulding is the preferable form of manufacture, it will be appreciated that any other suitable manufacturing process can be used. The mobilisation device 1 is composed entirely of glass filled nylon. However, it will be appreciated that the mobilisation device may be compose only partially of glass filled nylon, and partially of any other suitable materials. Alternatively, the mobilisation device may be composed entirely of a material other than glass filled nylon, such as, but not limited to wood, aluminium or silicon. However, it will be appreciated that any other suitable material may be used.

The mobilisation device 1 provides a number of advantageous features. In particular, the specific radius of the arcuate formation 4, first end 6 or second end 8 can exert a much greater pressure on the trigger points of the muscles. Furthermore, the device 1 provides multiple therapeutic surfaces to work the muscles and can be used on different parts of the body through selecting the most appropriate configuration.

The mobilisation device 1 can be arranged in a short configuration, as shown in FIG. 1, wherein the second therapeutic surface 12 primarily applies concentrated pressure on an area 10 of a user 11 when in use. In this short configuration, the arcuate formation 4 acts as a stabiliser to hold the device 1 in place and reduce unwanted movement of the second therapeutic surface 12. This is advantageous in providing mobilisation for joints and muscles on all areas of the body including at least a user's muscles in the neck, back, legs and arms.

Alternatively, the device 1 can be arranged in a tall configuration, as shown in FIG. 2, wherein the first therapeutic surface 10 primarily applies concentrated pressure on an area 10 of a user 11 when in use. In this tall configuration, the base acts to stabilise the device 1 in place and reduce unwanted movement of the first therapeutic surface 10. This is advantageous in providing a massaging effect with relatively more pressure than the short configuration for the user's muscles in the legs, lower back, upper back, and calves.

The predetermined height of the mobilisation device 1 in the tall configuration is in the range of 130 mm to 220 mm. The predetermined height of the mobilisation device in the short configuration is in the range of 50 mm to 120 mm

### Mobilisation Device in Use

The mobilisation device utilises a material science concept called creep. Creep describes where a material has a concentrated force applied to it over time and that material yields to that force. Muscle fascia is a very strong material as it transmits all the forces that a body experiences. This strong material can constrain a muscle from functioning properly by stopping the muscle to lengthen or to increase its cross-sectional area during contraction which decreases the force the muscle can produce. It also constrains the blood flow in that muscle which decreases the endurance and recovery of that muscle.

Advantageously, the mobilisation device provides a static, localised pressure on a specific area. The mobilisation device doesn't require manual movement of a device such as a foam roller or a roller ball to achieve that pressure. Rather, it enables a static pressure to be applied by using the weight of the body on the device. In contrast to foam rollers which provide a diffuse pressure that can increase pain by stirring up the nerves in the area and increase muscle spasms, the mobilisation device concentrates static pressure on a localised area.

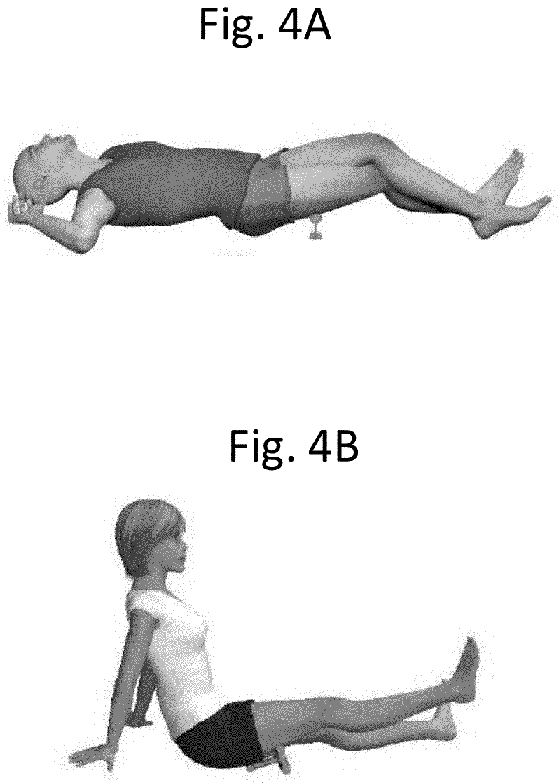

The mobilisation device can be used to treat muscles or joints by laying the muscle or joint which is sore on the device, as shown in FIG. 4A. The muscle should be stretched before and after using the device. The pain experienced when resting the muscle on the device should ideally not be more than a four or five on a scale of zero to ten, where zero is no pain at all and ten is the strongest pain. If the pain experienced is more than a four or five, then the pressure of the device can be reduced by placing a towel or a pillow over the device or on either side of the device. The mobilisation device may also be used in its short configuration to reduce pressure, as shown in FIG. 4B. Upon laying the muscle or joint on the device, body weight is used to enable the device to apply concentrated pressure. The pain should start to decrease within the first couple of minutes and continue to reduce as time goes on. If this does not happen then use of the device should be stopped, as the muscle may be too sore to use the device at this stage. If the original placement of the device on the muscle or joint doesn't hurt or doesn't feel stiff or tight then the device can be moved to an area adjacent to that spot. The device should be used to find spots that are tense and sore so that they can be softened through the concentrated pressure.

### Sideways Stretching

Advantageously, the mobilisation device can stretch the muscles sideways which is not possible with other approaches. Sideways stretching of muscles is very effective in stretching adhesions and the fascial sheath continuum which surrounds all the muscles and sticks muscles to each other and other surrounding structures.

Sideways stretching of the muscles is achieved by placing muscles to be stretched, such as the quads, calf, groin and hamstrings, in the middle of the device and rotating the leg away from the body. Then rocking back and forth on the device until the device can be felt pushing the muscle sideways. This position should be held as long as possible as this will release the tight tissues and improve range of motion.

### Hamstrings

Start with just one leg on the device and as the pain subsides, another leg can be added increase t pressure. Locate the device on the area that causes the most problems. Use the tall configuration for the lower half of the hamstrings as shown in FIG. 4A and the short configuration for the upper half, as shown in FIG. 4B. When using the short configuration, you can sit upright to increase the pressure it produces.

### Calf

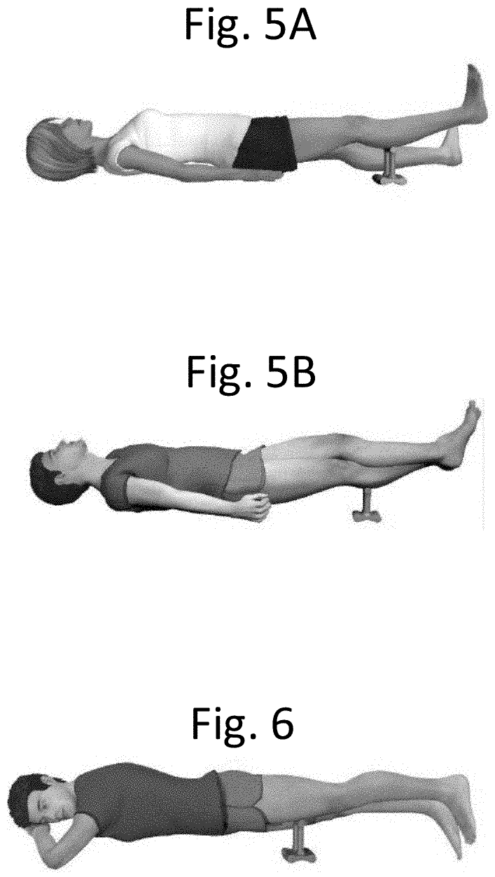

Start off with calf on the mobilisation device, as shown in FIG. 5A. If there are no issues then the other leg can be placed on top to increase the pressure, as shown in FIG. 5B. At some point the device will stretch the muscle fascia and the pain may increase sharply. If this is the case, the leg should be lifted off the device until the pain subsides then the leg back can be placed back on the device. Achilles Tendon issues can also be treated in this position.

### Quadriceps

Start off with the short configuration on the device and progress to the tall configuration, as shown in FIG. 6, as the pressure subsides with the short configuration. Hip joint tissues can also be treated in this position.

The quads can be stretched with a sideways stretch by turning the foot away from the body, then rolling from side to side until the device is felt to be pushing on the side of the muscle. That position should be held until the pain or tightness subsides.

### Hip Joint

The tissues at the front of the hip joint can be stretched sideways in this position to increase extension of that joint. These tissues can be very tight and will take some time to soften so persistence is required to get a good result.

### Neck Extension, Side Bending & Rotation

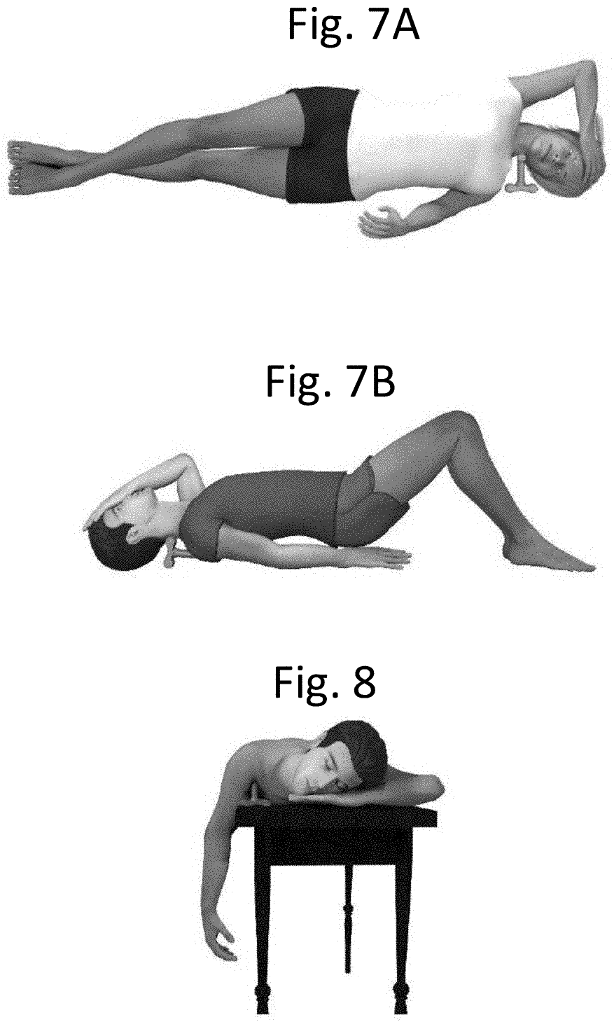

Mobilisation can used with the short configuration and tall configuration in side bending, as shown in FIGS. 7A and 7B to treat the neck. Care should be taken when using the device on the neck as the device can produce a lot of force, and the neck is a delicate structure which can be injured if pushed. The device should not be used on any unstable segments.

### Chest

As shown in FIG. 8, position the device under the pectoral muscle especially close to the shoulder joint to stretch the pectoral muscle and push the shoulder girdle back if it has moved forward with a tight pectoral. The bicep and forearm can also be treated in this position by placing the device under those areas.

### Upper, Middle and Lower Spine

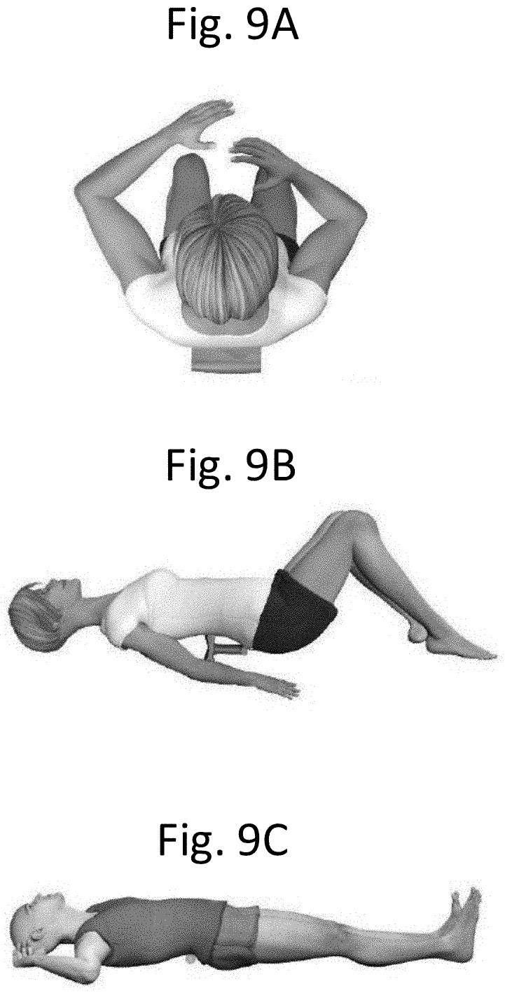

The upper, middle and lower spinal areas can be mobilised in the positions using the short configuration as shown in FIGS. 9A, 9B and 9C. The tall configuration is never used for these parts. Use of the device should be started with a short test period of just a few minutes until it is clear that the device will not increase the pain for no more than a few minutes.

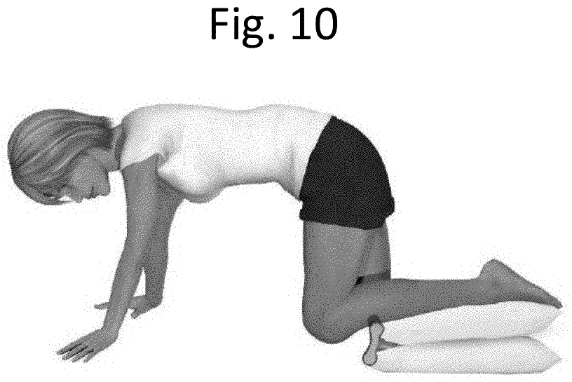

Shin Splints can be treated in the position as shown in FIG. 10.

Throughout this specification, use of the term “formation” is intended to mean either a single unitary component or a collection of components that combine to perform a specific function or purpose.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

It should be appreciated that in the above description of exemplary embodiments of the disclosure, various features of the disclosure are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some, but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Thus, while there has been described what are believed to be the preferred embodiments of the disclosure, those skilled in the art will recognise that other and further modifications may be made thereto without departing from the spirit of the disclosure, and it is intended to claim all such changes and modifications as fall within the scope of the disclosure.

1. A mobilisation device, comprising:
two or more therapeutic surfaces for applying concentrated pressure to an area of a user, the therapeutic surfaces being connected by at least one support formation.

2. A mobilisation device according to claim 1, comprising an arcuate formation extending from a distal end of the at least one support formation.

3. A mobilisation device according to claim 2, wherein a first therapeutic surface is defined by the arcuate formation.

4. A mobilisation device according to claim 3 wherein the first therapeutic surface is a linearly arranged therapeutic surface.

5. A mobilisation device according to claim 1, comprising a base connected to a proximal end of the at least one support formation.

6. A mobilisation device according to claim 5, wherein a second therapeutic surface is defined by a first end of the base.

7. A mobilisation device according to claim 6 wherein the first end is substantially arcuate to define the second therapeutic surface.

8. A mobilisation device according to claim 6 wherein the second therapeutic surface is a linearly arranged therapeutic surface.

9. A mobilisation device according to claim 5, wherein a third therapeutic surface is defined by a second end of the base.

10. A mobilisation device according to claim 9 wherein the second end is substantially arcuate to define the third therapeutic surface.

11. A mobilisation device according to claim 9 wherein the third therapeutic surface is a linearly arranged therapeutic surface.

12. A mobilisation device according to claim 5, wherein the base is substantially planar.

13. A mobilisation device according to claim 5, wherein the base is contoured on at least one surface, thereby to define a recess into which a user's head may rest.

14. A mobilisation device according to claim 1 wherein a radius of curvature of each of the two or more therapeutic surfaces are the same.

15. A mobilisation device according to claim 1, wherein a radius of curvature of each of the two or more therapeutic surfaces are different.

16. A mobilisation device according to claim 5 wherein the support formation is integrally formed with the base.

17. A mobilisation device according to claim 2 wherein the at least one support formation is integrally formed with the arcuate formation.

18. A mobilisation device according to claim 1 wherein the at least one support formation is elongate.

19. A mobilisation device according to claim 1, including two support formations arranged substantially in parallel to one another.

20. A mobilisation device according to claim 1 wherein the length of the at least one support formation is selectively adjustable between a retracted position in which the support formation has a first length and an extended position in which the support formation has a second length, wherein the second length is greater than the first length.

21. A mobilisation device according claim 1, wherein the mobilisation device is at least partially formed by injection moulding.

22. A mobilisation device according to claim 1, wherein the mobilisation device is composed at least partially of glass filled nylon.

23. A mobilisation device according to claim 1, wherein the device is oriented to define a short configuration.

24. A mobilisation device according to claim 1, wherein the device is oriented to define a tall configuration.
